(19) United States
(12) Patent Application Publication
(10) Pub. No.: US 2009/0047072 A1
(43) Pub. Date: Feb. 19, 2009

(54) INSTALLATION FOR CONVEYING SUPERHEATED FLUID

(75) Inventors: John Sinclair Reid, Cygnet (AU); Peter John Nielsen, Sandy Bay (AU)

Correspondence Address: MICHAEL BEST & FRIEDRICH LLP, 100 E WISCONSIN AVENUE, Suite 3300, MILWAUKEE, WI, 53202, US

(73) Assignee: ECOFLUIDICS PTY LTD, Sandy Bay (AU)

(21) Appl. No.: 12/167,323

(22) Filed: Jul. 3, 2008

(30) Foreign Application Priority Data
Jul. 3, 2007 (AU) 2007903656
Dec. 18, 2007 (AU) 2007906918

(51) Int. Cl. F16L 1/12; G21C 1/04

(52) U.S. Cl. 405/159; 165/45; 376/347

(57) ABSTRACT

An installation for conveying superheated fluid discharged from a vent located at or near the base of a body of water. The installation comprises a hood for locating the installation over the vent, and an insulated conduit that is in fluid communication with the hood and extends upwardly through the body of water.

### BACKGROUND OF THE INVENTION

The present invention relates to an installation for conveying superheated fluid that is discharged from a vent located at or near the base of a body of water.

It is known to utilize geothermal energy for heating, power generation and desalination. In these applications, the energy is conveyed in the form of heat from a location beneath the Earth's surface to a facility on the Earth's surface, which utilizes that energy for its desired purpose.

These applications use geothermal energy that is brought to the Earth's surface through vents or cracks, or through wells specifically drilled into the Earth's surface. For many reasons, including the accessibility of vents, existing facilities that utilize geothermal energy are land based and located near vents, etc. that are also formed in land, as opposed to in the sea floor.

Geothermal energy is also released through natural hydrothermal vents in the sea floor that discharge water heated by the geothermal energy.

Hydrothermal vents fed by geothermal energy can be found in mid-oceanic ridges, which are typically at depths of 2000 metres or greater below sea level. Vents in these locations typically discharge fluid at temperatures in the order of 350° C. to 400° C. Hydrothermal vents that are also fed by geothermal energy can be found in volcanic arcs, which are typically at depths of approximately 150 to 400 metres below sea level. Vents in these locations typically discharge fluid at temperatures in the order of 160° C. to 200° C.

### SUMMARY OF THE INVENTION

The present invention has been conceived to utilize energy of heated water discharged from a vent located at or near the base of a body of water. The vents can be natural hydrothermal vents or artificial vents fed by artificial underwater heat sources.

The present invention provides an installation for conveying superheated fluid discharged from a vent located at or near the base of a body of water, the installation comprising:
a hood for locating the installation over the vent; and
an insulated conduit that is in fluid communication with the hood and extends upwardly through the body of water.

Thus, heated fluid that is discharged from the vent is captured by the hood and directed into the insulated conduit, which directs the fluid upwardly towards the surface of the body of water, or land above or adjacent the body of water.

In certain embodiments, the conduit comprises a series of cylindrical sections, the internal diameter of the cylindrical sections increasing with distance from the hood.

The series of cylindrical sections can be configured to maintain an approximately constant fluid velocity within the conduit.

Alternatively or additionally, the series of cylindrical sections can be constructed such that the pressure tolerance of sections within the series increases with distance from the hood.

In some embodiments, the conduit further comprises one or more conical sections that interconnect adjacent cylindrical sections within the series.

In such embodiments, the series of cylindrical sections and the one or more conical sections are configured to maintain an approximately constant fluid velocity within the conduit.

Alternatively or additionally, the series of cylindrical sections and the one or more conical sections are constructed such that the pressure tolerance of sections within the series increases with distance from the vent.

In certain embodiments, the upper end of the cylindrical section that is connected to the hood is positioned at approximately the same depth as the depth of vapourization of fluid conveyed through the conduit.

In certain embodiments, the hood is thermally insulated.

The hood may be provided with an overflow discharge.

Thus, if the rate of flow of fluid entering the conduit is lower than the rate of flow of superheated fluid discharged from the vent, the excess fluid can be discharged through the overflow discharge.

In certain embodiments, the overflow discharge may be in the form of one or more holes located around the base of the hood.

The installation may further comprise a series of buoys and/or anchors attached to the conduit to maintain the conduit in a generally constant configuration.

In certain embodiments, the installation may further comprise a heat engine that converts energy within the fluid exhausted from the conduit into mechanical motion.

The heat engine may be located at or above the surface of the body of water. In these embodiments, the upper end of the conduit may terminate at or above the surface of the body of water.

In some applications, the body of water is the sea, and the vent is located on or near the sea floor.

Preferably, the upper end of the conduit may terminate below the sea surface, such that fluid can be discharged from the conduit into the upper layers of the sea.

Preferably, fluid exhausted from the insulated conduit creates a plume which causes the transport of surrounding sea water from one level in the sea to a higher level.

In some alternative embodiments, the installation further comprises a bubble pump located beneath the sea surface, and the upper end of the conduit terminates inside the bubble pump, such that fluid exhausted from the conduit drives the bubble pump.

Preferably, the bubble pump comprises a thin walled conduit.

In some embodiments, the vent is a natural hydrothermal vent.

In some alternative embodiments, the installation further comprises a nuclear reactor that heats fluid that is discharged into the conduit through the vent and hood combination or other connector.

The present invention also provides an installation for conveying superheated fluid discharged from a plurality of vents located on the sea floor, the installation comprising a plurality of installations as described above, the hood of each installation being located over a respective one of the vents, the upper ends of the insulated conduits of the installations being arranged below the sea surface to form a vertical set of plumes.

The present invention also provides an installation for conveying superheated fluid discharged from a plurality of vents located on the sea floor, the installation comprising a plurality of installations as described above, the hood of each installation being located over respective vents, the upper ends of the insulated conduits of the installations being arranged below the sea surface to form a horizontal array of plumes.

The present invention also provides a method of conveying thermal energy from a vent located at or near the base of a body of water, the vent discharging superheated fluid, the method comprising the steps of:
a) installing an installation over the vent, the installation comprising a hood that is in fluid communication with an insulated conduit, such that superheated fluid discharged from the vent is directed by the hood into the insulated conduit; and
b) conveying fluid upwardly in the insulated conduit and through the body of water.

Preferably, step (b) further comprises conveying the fluid in a manner such that the fluid at least partly vapourizes as it rises within the conduit.

Preferably, such that fluid at the upper end of the insulated conduit is at least a two-phase fluid.

In embodiments in which the installation further comprises a heat engine that receives fluid exhausted from the conduit, the method can further comprise converting the enthalpy of the fluid into mechanical energy in the heat engine.

In some embodiments in which the body of water is the sea, the method can further comprise discharging fluid from the conduit below the sea surface such that the buoyancy of the at least two-phase fluid creates a plume that mixes sea water between different levels by entrainment within the plume.

In embodiments in which the body of water is the sea and the installation further comprises a bubble pump located beneath the sea surface and the upper end of the insulated conduit terminates inside the bubble pump, the method can further comprise discharging the at least two-phase fluid from the conduit inside the bubble pump to drive a bubble pump and create an upward flow of water through the bubble pump.

The installation and method can be configured such that deep water containing nutrients can be brought into the well-lit upper layers of the sea so as to increase the productivity of photosynthesizing organisms.

In such embodiments, a marine ecosystem may be created or enhanced in order to increase fish catch.

Alternatively or additionally, a marine ecosystem is created or enhanced in order to export carbon dioxide from the atmosphere by increased photosynthesis.

The method may further comprise mixing layers of the sea in order to bring deep water of high alkalinity toward the sea surface and increase the solubility of carbon dioxide in the mixed layer.

The method may further comprise dissolving carbon dioxide from the atmosphere in the sea.

In embodiments in which the installation further comprises a nuclear reactor, the method can further comprise heating fluid using energy generated by the reactor, the heated fluid being discharged into the conduit.

### BRIEF DESCRIPTION OF THE DRAWINGS

In order that the invention may be more easily understood, embodiments will now be described, by way of examples only, with reference to the accompanying drawings, in which:

FIG. 1: is a schematic view showing three installations according to a first embodiment of the present invention;

FIG. 2: is a chart showing pressure as a function of depth for an installation according to an embodiment of the present invention with an intake depth of 200 m;

FIG. 3: is a chart showing temperature plotted a function of depth for an installation according to an embodiment of the present invention with an intake depth of 200 m;

FIG. 4: is a chart showing specific volume as a function of depth for an installation according to an embodiment of the present invention with an intake depth of 200 m;

FIG. 5: is a chart showing steam quality as a function of depth for an installation according to an embodiment of the present invention with an intake depth of 200 m;

FIG. 6: is a chart showing pressure as a function of depth for an installation according to an embodiment of the present invention with an intake depth of 2500 m;

FIG. 7: is a chart showing temperature as a function of depth for an installation according to an embodiment of the present invention with an intake depth of 2500 m;

FIG. 8: is a chart showing specific volume as a function of depth for an installation according to an embodiment of the present invention with an intake depth of 2500 m;

FIG. 9: is a chart showing steam quality as a function of depth for an installation according to an embodiment of the present invention with an intake depth of 2500 m;

FIG. 10: is a schematic view of an installation according to a second embodiment of the present invention; and

FIG. 11: is a schematic view of an installation according to a third embodiment of the present invention.

### DETAILED DESCRIPTION

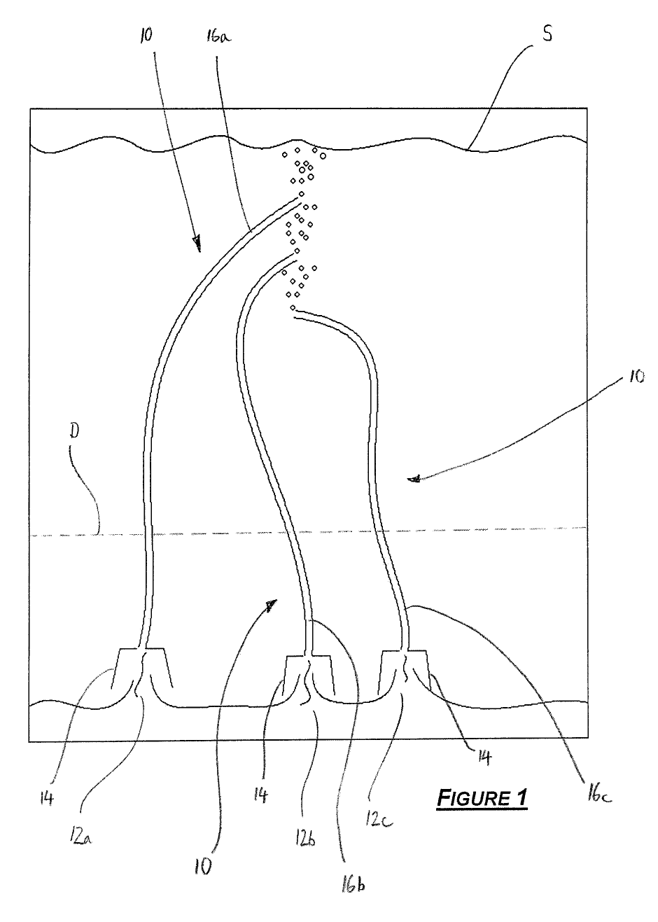

FIG. 1 shows three installations 10, each in accordance with a first embodiment of the present invention. Each of these installations is arranged to convey superheated fluid discharged from a vent 12a, 12b, 12c located at the base of a body of water. In this embodiment, the body of water is the sea, and the vents 12a, 12b, 12c are natural hydrothermal vents located on the sea floor. Each installation has a hood 14 for locating the installation 10 over one of the vents. A conduit 16 in fluid communication with the hood 14 extends upwardly through the sea and towards the sea surface S.

The hood 14 anchors the lower end of the conduit 16 over the vent 12, and collects and directs fluid, in the form of superheated liquid, discharged from the vent 12 into the conduit 16. Fluid discharged from the vent 12 is initially conveyed upwardly through the conduit 16 due to inertia. However, as will be appreciated, natural buoyancy encourages fluid to rise upwardly through the conduit 16.

To reduce the heat loss from the heated fluid to the surrounding sea, the conduit 16 is insulated. The hydrostatic pressure on the fluid decreases as it travels upwardly through the conduit 16. At appropriate temperature and pressure conditions, the fluid undergoes a phase change from liquid to vapour. The level at which this phase change begins to occur is indicated in FIG. 1 by the dashed line D. For the purposes of this specification, this level is referred to as the “depth of vapourization”.

Each of the embodiments of the installation 10 shown in FIG. 1 is arranged such that the upper end of the conduit 16 terminates below sea level. Fluid exhausted from the upper end of each conduit 16 forms an unconstrained plume, which mixes with sea water in the vicinity the upper end of the respective conduit 16. The plume has a low density and is more buoyant than sea water. Convective forces raise the plume and the entrained sea water toward the sea surface S to create an upwelling, which creates a mixing effect in the upper levels of the sea.

An unconstrained plume will attain a limiting height at which it loses so much buoyancy by entrainment that it dissipates and spreads horizontally.

In the embodiment illustrated in FIG. 1, the hood 14 is insulated to minimize heat transfer from the superheated fluid discharged from the respective vent 12, through the hood 14 to the surrounding sea water, which can typically be in the range of 8-16° C. in the region of hydrothermal vent “communities”.

The hood 14 may be provided with an overflow discharge (not shown).

The overflow discharge enables excess fluid to escape the installation 10 should the rate of flow of fluid entering the conduit 16 fall below the rate of flow of superheated fluid discharged from the hydrothermal vent 12.

In certain embodiments, the overflow discharge can be in the form of one or more holes located around the base of the hood.

As shown in FIG. 1, the conduits 16 of each of the three installations are of different length. In addition, the upper ends of the conduits 16 are arranged in an ascending sequence. An assembly (not shown) of mooring lines, ballasts and buoyancy devices are used to maintain the upper ends of the conduits 16 in the schematically illustrated arrangement.

In the arrangement of FIG. 1, the three installations co-operate to form a vertical set of unconstrained plumes. Specifically, the upper ends of the insulated conduits 16 of the installations are arranged below the sea surface to form a vertical set of plumes. That is, the plume formed at the upper end of the deepest conduit 16c rises and mixes until it dissipates. The upper end of the intermediate conduit 16b is positioned to create a plume at the approximate depth of the limiting height of the plume formed immediately below. Similarly, the plume formed at the upper end of the intermediate conduit 16b rises and mixes until it dissipates. The upper end of the intermediate conduit 16b is positioned to create a plume at the approximate depth of the limiting height of the plume formed immediately below. In this way, mixing of the sea from deeper levels into the near-surface layer can be achieved.

The vertical separation of the upper ends of the conduits 16 can be arranged such that fluid is exhausted from the shallowest and intermediate conduits 16a, 16b at or near the limiting height of the unconstrained plume formed by the conduit(s) at deeper levels.

Modelling of fluid flow through the conduit 16 indicates that the depth of vapourization is predominantly dependent on the temperature of fluid discharged from the vent and the vent depth. In addition, modelling has made it evident that the fluid behaviour is almost independent of the dimensions (length and diameter) of the conduit 16.

To determine depth of vapourization, amongst other operating parameters of the sub-sea installation, a model was developed using Bernoulli's Equation for compressible fluid flow. The following section describes the development of such a model.

Primary assumptions were made regarding fluid behaviour in the conduit. These assumptions include that fluid velocity in the conduit is low, so velocity terms in the model can be ignored. Furthermore, velocities are small, so that friction with the conduit walls can also be neglected and the friction factor in the model can be assumed to be zero. Accordingly, the model has been developed based on a hydrostatic approximation.

Thermal conductivity losses are negligible since the conduit 16 is well insulated, which means that thermal conductivity terms in the model can also be ignored.

These assumptions reduce Bernoulli's Equation to:

$$\frac{d ( H + gz )}{d t} = 0 \qquad ( Equation 1 )$$

in which:
   H is the specific enthalpy,
   z is the depth (measured negatively downward),
   g is the acceleration due to gravity, and
   d/dt is the total differential “moving with the fluid”.

Thus, specific enthalpy is related to depth by:

[symbol]

(Equation 2)
in which H₀ is the specific enthalpy at a reference depth, z₀.

Specific enthalpy and specific internal energy, U, are related by:

H=U+pV (Equation 3)
in which V is the specific volume (inverse of density).

Substituting Equation 3 into Equation 2 and differentiating with respect to depth, z, gives;

$$\frac{d U}{d z} + V \frac{d p}{d z} + p \frac{d V}{d z} = - g \qquad ( Equation 4 )$$

Inside the conduit 16, hydrostatic pressure is related to height by:

$$\frac{d p}{d z} = - \frac{g}{V} \qquad ( Equation 5 )$$

Hence, for a hydrostatic fluid in the non-horizontal conduit:

$$\frac{d V}{d p} = - \frac{1}{p} \frac{d U}{d p} \qquad ( Equation 6 )$$

Integrating Equation 6 with respect to p gives the specific volume, V, in terms of internal energy, U, and pressure, p, as follows:

$$V = {V}_{0} - {\int }_{{p}_{0}}^{p} \frac{d U}{p} \qquad ( Equation 7 )$$

where V₀ is the specific volume at a reference pressure, p₀.

In the domain of interest, the two phase domain, the temperature is the saturation temperature which is a unique function of the pressure, as follows:

T=Tₛₐₜ(p) (Equation 8)

That is, the thermodynamic quantities, V, U and H, become functions of the single variable, p, for both vapour and liquid phases. In equilibrium, these quantities are each the weighted sum of the corresponding vapour and liquid values. For example, specific energy is:

U=qUᵥ+(1−q)Uₗ (Equation 9)
in which:
   Uᵥ is the specific internal energy of the vapour phase, and
   Uₗ is the specific internal energy of the liquid phase.

While Uᵥ and Uₗ are known functions of the pressure for the saturated mixture, the total specific internal energy, U, can only be determined once the vapour mass fraction, is known. The mass vapour fraction can be considered as a measure of the “quality”, q, of the steam.

The total enthalpy, H, given by Equation 1 can be assumed to be constant for small changes in depth, and the steam quality, q, can then be found from:

$$q = \frac{H - {H}_{l}}{{H}_{v} - {H}_{l}} \qquad ( Equation 10 )$$

The steam quality, measured in this way, is used in Equation 9 to determine the total specific internal energy, U, at each pressure level.

Thus, the specific volume, V, may be evaluated as a unique function of the pressure using Equation 7. This may be integrated, in turn, according to Equation 5 to give depth as a function of pressure, as follows:

$$z = {z}_{0} - \frac{1}{g} {\int }_{{p}_{0}}^{p} V d p \qquad ( Equation 11 )$$

in which z₀ is the depth of the reference pressure p₀.

Thus, by iteration, the depth of vapourization, and values of specific enthalpy, H, and steam quality, q, can be determined.

The model can be used to estimate the following fluid properties, each as a function of depth below sea level, within the conduit 16:
1. Internal pressure, which can provide pressure at the upper end of the conduit 16;
2. Temperature, which can provide temperature at the upper end of the conduit 16;
3. Specific Volume, from which information regarding the density of fluid, and fluid velocity on exhausted from the upper end of the conduit 16 can be obtained; and
4. Steam quality.

The above four fluid properties can be used to determine performance parameters of the desired application of the installation 10.

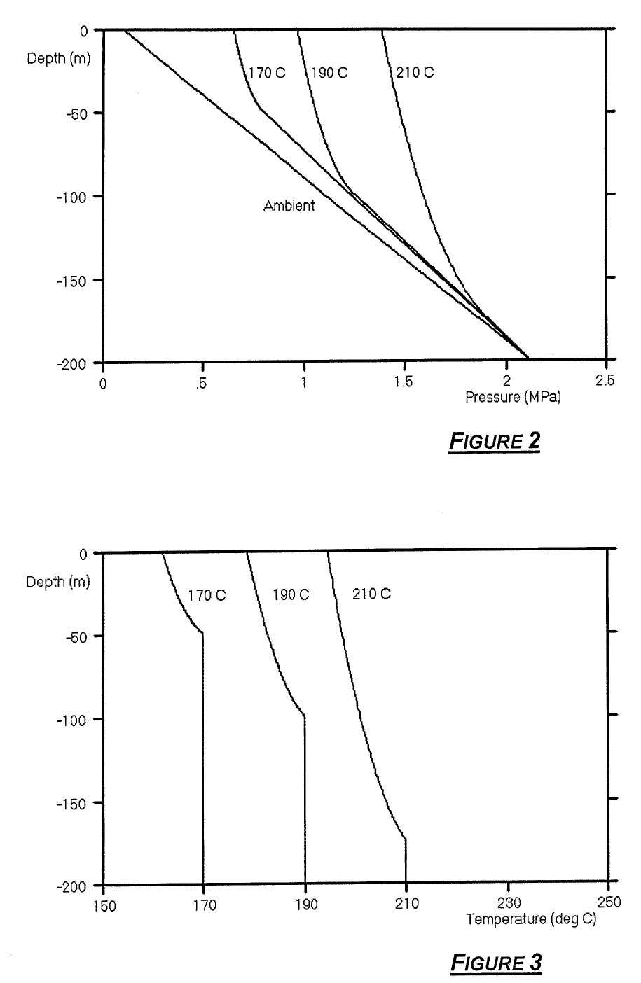

FIGS. 2 to 5 show indicative values of the above four fluid properties for an installation according to an embodiment of the present invention for each of three hypothetical natural hydrothermal vents located in the sea at a depth of 200 metres below sea level. The three vents have discharge temperatures of 170° C., 190° C. and 210° C. The installation includes a load that receives fluid discharged from the insulated conduit. The fluid properties shown in each of FIGS. 2 to 5 have been calculated using the above described model.

In FIG. 2, pressure outside the conduit 16, labelled “Ambient”, is also shown.

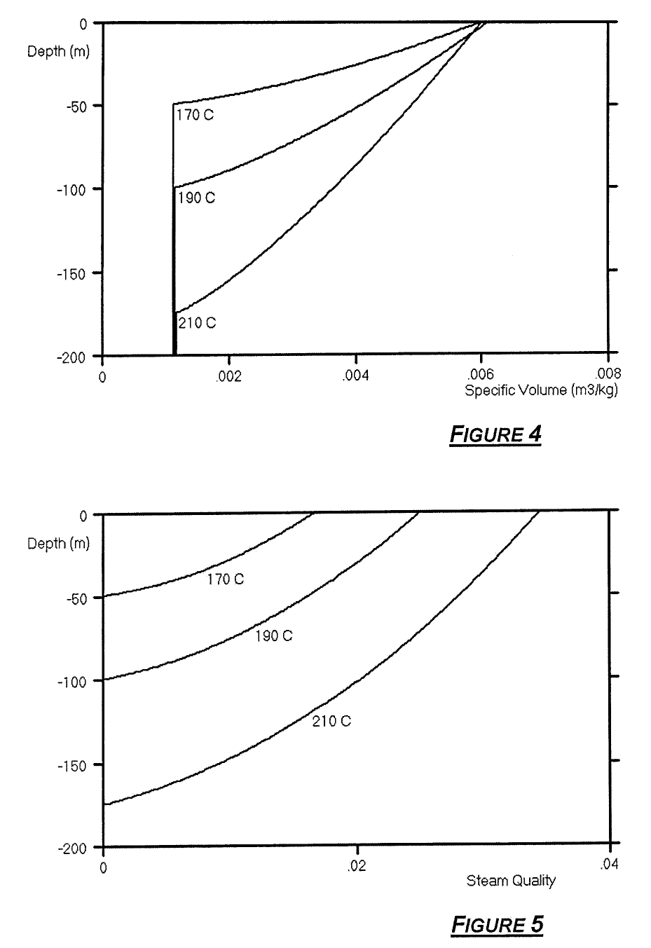

In each of FIGS. 3 and 4, the depth of vapourization can be readily observed as a discontinuity in the curve of each respective vent. The approximate depth of vapourization for each of the three hypothetical vents, located at a depth of 200 m below sea level, is set out in the following table.

| Vent discharge temperature | Depth of vapourization |
|---|---|
| 170° C. | 50 metres |
| 190° C. | 100 metres |
| 210° C. | 175 metres |

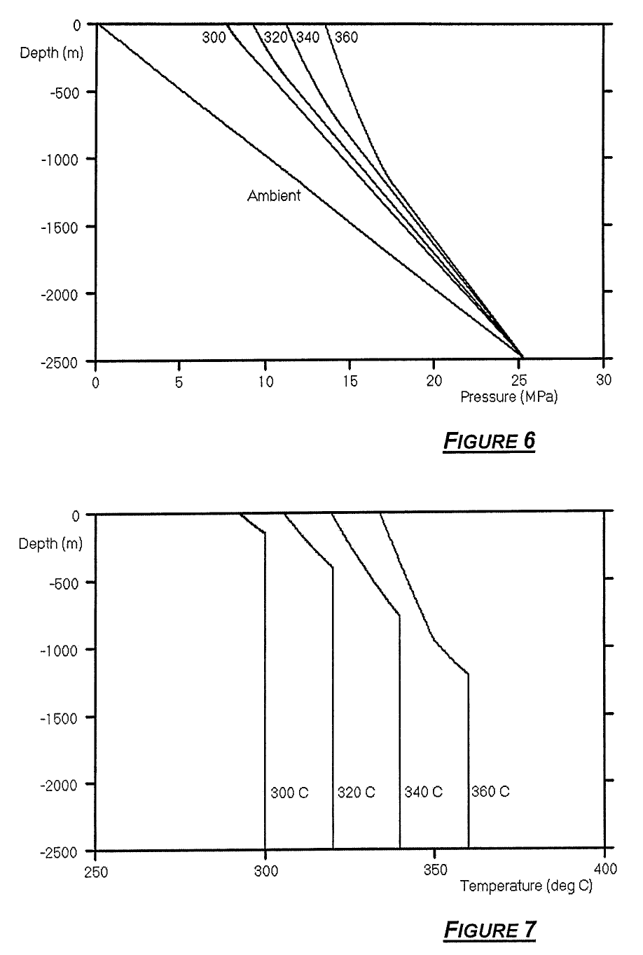

FIGS. 6 to 9 show indicative values of the above four fluid properties for an installation according to an embodiment of the present invention for each of four hypothetical natural hydrothermal vents that are located in the sea at a depth of 2500 metres below sea level. The four vents have discharge temperatures of 300° C., 320° C., 340° C. and 360° C. The installation includes a load that receives fluid discharged from the insulated conduit. The fluid properties shown in each of FIGS. 6 to 9 have been calculated using the above described model.

In FIG. 6, pressure outside the conduit 16, labelled “Ambient”, is also shown.

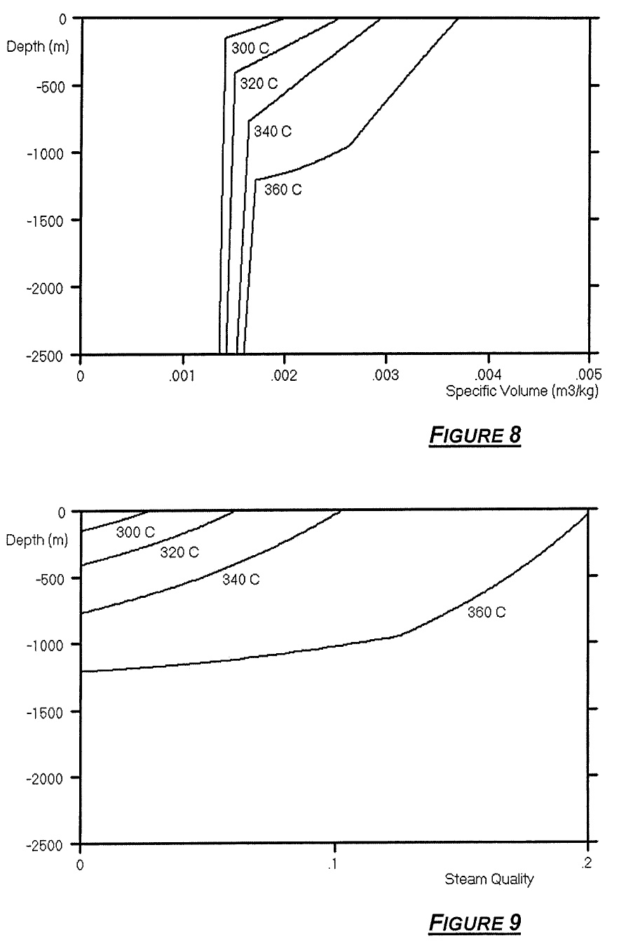

In each of FIGS. 7 and 8, the depth of vapourization can be readily observed as a discontinuity in the curve of each respective vent. The approximate depth of vapourization for each of the four hypothetical vents, located at a depth of 2500 m below sea level, is set out in the following table.

| Vent discharge temperature | Depth of vapourization |
|---|---|
| 300° C. | 150 metres |
| 320° C. | 420 metres |
| 340° C. | 775 metres |
| 360° C. | 1200 metres |

The analytical modelling as described above leads to some important consequences for applications of sub-sea installations according to embodiments of the present invention, which utilize the power of an underwater hydrothermal vent. These include the following:
Fluid pressures within the conduit 16 at sea level are generally high, particularly for vents of depths in the order of 2500 metres below sea level.
Fluid temperatures within the conduit 16 at sea level are acceptable for heat-engine input.
The steam quality is very low (less than 20% at sea level, and as low as 2% for shallow, low temperature vents). For a vent at depth of 2500 metres with a discharge temperature of 280° C., no phase change occurs (that is, the steam quality is zero at sea level).
There is a steady increase in the pressure difference between the interior and exterior of the conduit 16 with decreasing depth.
There is a large differential specific volume (between the ends of the conduit in an installation) for shallow depth, low temperature vents. Hence, if the cross section of the conduit is constant, there would be a corresponding large differential in fluid velocity.

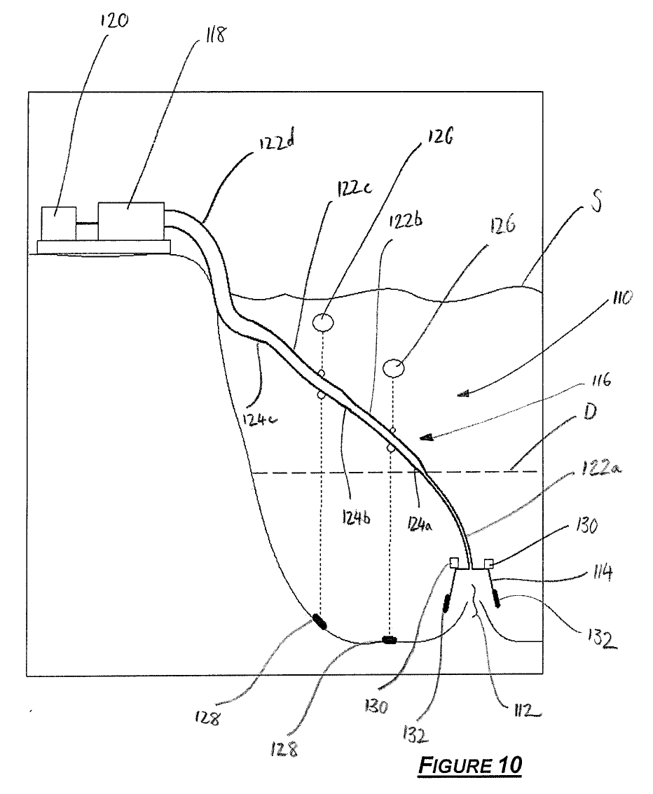

FIG. 10 shows an installation 110 in accordance with a second embodiment of the present invention. The installation 110 is arranged to convey superheated fluid discharged from a vent 112 located at the base of a body of water. In this embodiment, the body of water is the sea, and the vent 112 is a natural hydrothermal vent located on the sea floor. The installation has a hood 114 for locating the installation 110 over the vent. A conduit 116 in fluid communication with the hood 114 extends upwardly through the sea towards the sea surface S.

The hood 114 anchors the lower end of the conduit 116 over the vent 112 and directs fluid discharged from the vent 112 into the conduit 116. Fluid discharged from the vent 112 is initially conveyed upwardly through the conduit 116 due to inertia. However, as will be appreciated, natural buoyancy encourages fluid to rise upwardly through the conduit 116.

To reduce the heat loss from the heated fluid to the surrounding sea, the conduit 116 is insulated. At appropriate temperature and pressure conditions, the fluid undergoes a phase change from liquid to vapour. The depth of vapourization is indicated in FIG. 10 by the dashed line D.

The installation 110 shown in FIG. 10 is arranged such that the upper end of the conduit 116 continues through the sea surface S and feeds into a heat engine 118, which in this embodiment is located on dry land. The heat engine 118 converts thermal energy within the fluid exhausted from the conduit 116 into mechanical motion that can be used to generate electricity by means of an electric generator 120.

In this embodiment, the conduit 116 is in the form of a series of cylindrical sections 122a, 122b, 122c, 122d (hereinafter referred to collectively as cylindrical sections 122) that are interconnected by conical sections 124a, 124b, 124c (hereinafter referred to collectively as conical sections 124). The series is arranged such that the inner diameter of the cylindrical sections 122 increases with proximity to the sea surface.

The lowermost cylindrical section 122a is connected at its lower end to the hood 114, and at its upper end to the lowermost conical section 124a. As shown in FIG. 10, the upper end of the lowermost cylindrical section 122a terminates at the depth of vapourization D.

As the water rises in the lowermost section 122a of the conduit 116, the hydrostatic pressure decreases. At the depth of vapourization the fluid begins to boil. The resulting two phase fluid continues to rise in conical section 124a, which has an internal diameter increasing with decreasing depth. Conical section 124a maintains the velocity of the fluid approximately constant while its specific volume increases with decreasing hydrostatic pressure. Conical section 124a is joined to a further cylindrical section 122b, which has a larger cross-sectional area compared to the lowermost cylindrical section 122a. Thus, the series of cylindrical sections 122 and the conical sections 124 are configured to maintain an approximately constant fluid velocity within the conduit 116.

As the two phase fluid rises further in the conduit 116, the liquid phase continues to boil and the fraction of vapour by mass (that is, the steam quality) continues to increase. The increasing steam quality and decreasing pressure cause the specific volume of the two phase fluid to increase still further.

In the embodiment illustrated in FIG. 10, the hood 114 is insulated to minimize heat transfer from the superheated fluid discharged from the respective vent 112, through the hood 114 to the surrounding sea water, which can typically be in the range of 2-16° C. in the region of hydrothermal vent “communities”.

The hood 114 may be provided with an overflow discharge (not shown). The overflow discharge enables excess fluid to escape the installation 110 should the rate of flow of fluid entering the conduit 116 fall below the rate of flow of superheated fluid discharged from the hydrothermal vent 112.

In certain embodiments, the overflow discharge can be in the form of one or more holes located around the base of the hood.

In certain conditions, such as those associated with shallower vents, a resonant behaviour may be established in the fluid column within the conduit, in which the fluid column resembles a Helmholtz resonator or a spring pendulum. The resonant behaviour is created by a length of liquid lower regions of the conduit or so leads into a vapour containing region further up the conduit. The length of liquid can be considered to be a “plug” of high inertia, and the vapour above the liquid being considered to be a “spring”.

If the resonant behaviour causes the liquid “plug” to oscillate in the conduit, the result can be catastrophic damage of the conduit or heat engine. To minimize such resonant behaviour, the friction term (from wall friction within the conduit) in the equation of motion must exceed the value required for critical damping. This can be achieved by decreasing the cross-section of the conduit, which results in an increase in the velocity of the fluid flow. If the velocity is increased sufficiently, the friction is of sufficient magnitude compared to the hydrostatic and thermodynamic terms to bring about critical damping.

However, narrowing the entire length of the conduit to this extent can create further problems where the greater specific volume results in proportionally greater velocity. High velocity flow in the conduit may lead to feedback between pressure drop and phase changes. Such feedback is likely to bring about chaotic behaviour with regard to pressure within the conduit and erratic phase changes.

Increasing the cross-section area of the conduit 116 above the depth of vapourization will maintain a roughly constant fluid velocity within the conduit.

This minimizes the likelihood of pressure and phase change irregularities. In the embodiment shown in FIG. 10, the series of cylindrical sections 122 and conical sections 124 form a “piecewise flaring” of the conduit 116 towards the sea surface, which serves to keep the fluid velocity within a narrow range that can be considered roughly constant.

In alternative embodiments of the installation, the conduit may be continuously flared above the depth of vapourization.

In certain conditions, such as those associated with deeper vents, a large pressure difference across the wall of the conduit is experienced above the depth of vapourization. For example, in an installation connected to a vent at 2500 metres that has a discharge temperature of 360° C., the pressure differential can be as much as 15 mPa. In installations for these applications, the conduit 116 can be constructed such that the series of cylindrical sections and the conical sections have increasing pressure tolerance with proximity to the sea surface. In some embodiments, this can be achieved by increasing the wall thickness of the series of cylindrical sections and the conical sections. Alternatively or additionally, this can be achieved by selection of materials that are used to construct the conduit 116.

As shown in FIG. 10, the installation 110 has a series of buoys 126 and anchors 128 attached to the conduit 116 to maintain the conduit 116 in a generally constant configuration. The buoys 126 and anchors 128 work against movement of the sea caused by ocean currents and the like, and any changes in buoyancy of the conduit 116 caused by changing fluid conditions in the conduit 116.

During installation, the hood 114 will need to be manoeuvred into position over the vent 112. The hood 114 has buoyancy tanks 130 that facilitate handling during this operation. The buoyancy tanks 130 can be filled with a buoyant fluid that is more buoyant than sea water surrounding the vent 112. This buoyant fluid can be any one or a mixture of: gases, liquid hydrocarbons, and sea water. Once the hood 112 is in the correct position, the buoyant fluid can be expelled from the tanks 130.

The hood 112 also has ballasts 132 that are attached to a lower part of the hood 112. The ballasts 132 work to hold the hood 112 firmly in position and prevent dislodgement due to the stresses of ocean currents.

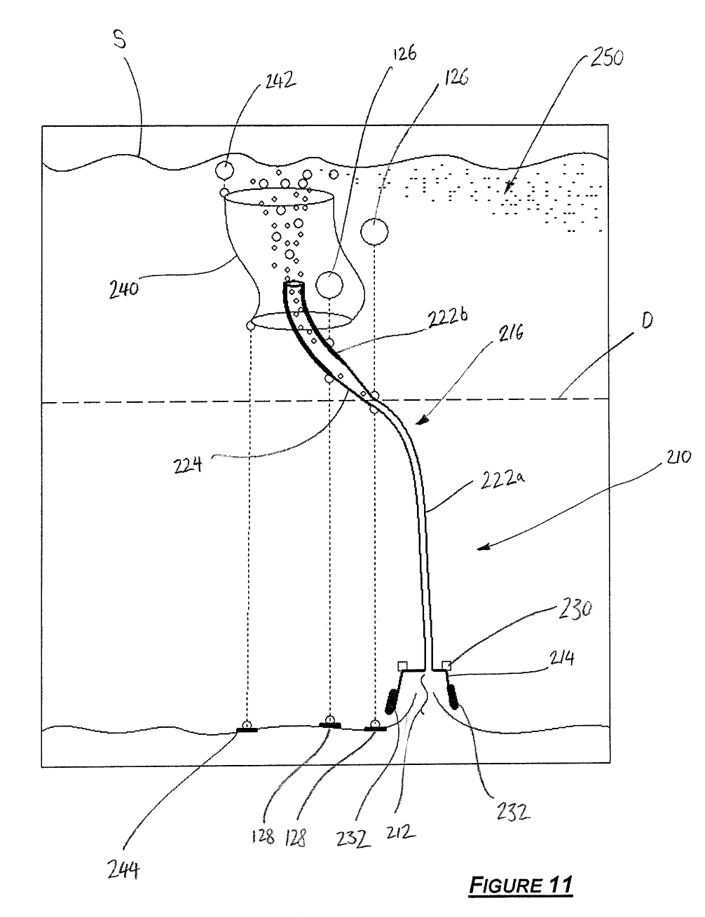

FIG. 11 shows an installation 210 in accordance with a third embodiment of the present invention. The installation 210 is arranged to convey superheated fluid discharged from a vent 212 located at the base of a body of water. In this embodiment, the body of water is the sea, and the vent 212 is a natural hydrothermal vent located on the sea floor. The installation has a hood 214 for locating the installation 210 over the vent 212. A conduit 216 in fluid communication with the hood 214 extends upwardly through the sea towards the sea surface S.

The hood 214 anchors the lower end of the conduit 216 over the vent 212 and directs fluid discharged from the vent 212 into the conduit 216. Fluid discharged from the vent 212 is initially conveyed upwardly through the conduit 216 due to inertia. However, as will be appreciated, natural buoyancy encourages fluid to rise upwardly through the conduit 216.

To reduce the heat loss from the heated fluid to the surrounding sea, the conduit 216 is insulated. At appropriate temperature and pressure conditions, the fluid undergoes a phase change from liquid to vapour. The depth of vapourization is indicated in FIG. 11 by the dashed line D.

In the embodiment illustrated in FIG. 11, the hood 214 is insulated to minimize heat transfer from the superheated fluid discharged from the respective vent 212, through the hood 214 to the surrounding sea water, which can typically be in the range of 2-16° C. in the region of hydrothermal vent “communities”.

The hood 214 may be provided with an overflow discharge (not shown). The overflow discharge enables excess fluid to escape the installation 210 should the rate of flow of fluid entering the conduit 216 fall below the rate of flow of superheated fluid discharged from the hydrothermal vent 212.

In certain embodiments, the overflow discharge can be in the form of one or more holes located around the base of the hood.

In this embodiment, the conduit 216 is in the form of a series of cylindrical sections 222a, 222b (hereinafter referred to collectively as cylindrical sections 222) and an interconnecting conical section 224. The series is arranged such that the inner diameter of the cylindrical sections 222 increases with proximity to the sea surface.

The lowermost cylindrical section 222a is connected at its lower end to the hood 214, and at its upper end to the conical section 224. As shown in FIG. 11, the upper end of the lowermost cylindrical section 222a terminates at the depth of vapourization D.

As the water rises in the lowermost section 222a of the conduit 216, the hydrostatic pressure decreases. At the depth of vapourization the fluid begins to boil. The resulting two phase fluid continues to rise in the conical section 224, which has an internal diameter increasing with decreasing depth. Conical section 224 maintains the velocity of the fluid approximately constant while its specific volume increases with decreasing hydrostatic pressure. Conical section 224 is joined to a further cylindrical section 222b, which has a larger cross-sectional area compared to the lowermost cylindrical section 222a.

The installation 210 has a series of buoys 226 and anchors 228 attached to the conduit 216 to maintain the conduit 216 in a generally constant configuration. The buoys 226 and anchors 228 work against movement of the sea caused by ocean currents and the like, and any changes in buoyancy of the conduit 216 caused by changing fluid conditions in the conduit 216.

The hood 212 also has buoyancy tanks 230 and ballasts 232 that operate in the manner of the buoyancy tanks 130 and ballasts 132 described in connection with the embodiment illustrated in FIG. 10.

The installation 210 further includes a bubble pump 240, which is located beneath the sea surface S. The bubble pump 240 is essentially a thin-walled conduit formed of a sea water impervious membrane. The inner diameter of the bubble pump 240 that is significantly greater than that of the upper end of the insulated conduit 216. The bubble pump 240 is arranged with its open ends arranged in approximately vertical alignment.

A series of buoys 242 and anchors 244 are attached to the ends of the bubble pump 240. The buoys 242 and anchors 244 work to maintain the bubble pump 240 in the approximate orientation illustrated in FIG. 11.

The upper end of the insulated conduit 216 terminates within the bubble pump 240. Fluid exhausted from the insulated conduit 216 drives the bubble pump 240. In particular, the fluid exhausted from the insulated conduit 216 forms a plume that has a relatively low density compared with the sea water immediately surrounding the upper end of the insulated conduit 216. Convective forces raise the plume toward the sea surface S. Movement of the plume draws water into the lower end of the bubble pump 240 to create an upward flow of water through the bubble pump 240.

The function of the bubble pump 240 is to contain the plume of low-density two-phase fluid and so inhibit mixing with colder sea water. Thus, the maximum height of the plume can be increased by controlling the mixing with sea water.

The cold water brought up from below the bubble pump 240 exits the bubble pump 240 and mixes into the upper, stratified layers of the ocean known as “the mixed layer” or the “euphotic zone”.

In many parts of the ocean, deeper water is richer in nutrients such as nitrates, phosphates, iron and silicon than is the euphotic zone, which is largely depleted of nutrients. Mixing water from these deeper layers into the euphotic zone will cause biological productivity to increase in the manner observed in a naturally occurring ocean upwelling because deep-lying nutrients are brought into the euphotic zone where light is available for photosynthesis.

Thus, the installation 240 generates an artificial upwelling that increases biological productivity in the same way as a natural upwelling. This increased productivity will either enhance an existing marine ecosystem or cause a new marine ecosystem 250 to come into existence and be continuously maintained as long as the installation 210 is in operation.

The bubble pump 240 is able to move very large volumes of sea water because the density of steam is orders of magnitude less than the density differences of the sea water being pumped. Hence the potential energy provided by unit mass of steam at depth is orders of magnitude greater than the potential energy required to raise unit mass of sea water. A small amount of steam is able to raise a very large amount of sea water. It is envisaged that an installation 210 located over a 10 MW hydrothermal vent can generate upwelling flows through the bubble pump 240 of the order of milli-Sverdrups, which is the flow rate of a medium-sized river.

A typical bubble pump 240 could have an internal diameter of the order of 10 metres. The upper end of such a bubble pump 240 would be disposed at a depth of approximately 5 to 10 metres.

The depth of the lower end of the bubble pump 240 is preferably within the layers of the sea that are the richest with regard to the desired nutrients. In shallow vent applications, this depth may be limited by the sea bed. In deep vent applications, the depth of the lower end is likely to be in the region of 800 to 1000 metres.

The installation 240, when operated in a region where high nutrient concentrations and high alkalinity occur at depth, can also cause carbon-dioxide to be removed from the atmosphere. Photosynthesis takes place as a consequence of the increase in nutrients close to the surface where sunlight is available. The carbon is immediately taken up by the biomass, which is likely to be primarily plankton. Over time it becomes sequestered in the deep ocean for millennia and, more permanently, in sediment on the ocean floor when detritus falls out of the artificial marine ecosystem that has been created. The embodiment can also have the effects of cooling the surface layer of the ocean and decreasing its acidity. Increased alkalinity of the mixed layer also results in carbon dioxide being removed from the atmosphere due to its increased solubility with the sea water.

Some embodiments of the invention provide a method of conveying thermal energy from a vent located at the base of a body of water, the vent discharging superheated fluid. The method involves:
a) installing an installation over the hydrothermal vent, the installation comprising a hood that is in fluid communication with an insulated conduit, such that superheated fluid discharged from the vent is directed by the hood into the insulated conduit; and
b) conveying fluid upwardly in the insulated conduit and through the body of water.

In step (b), fluid can be conveyed in a manner such that the fluid at least partly vapourizes as it rises within the conduit. In this way, fluid that is exhausted from the upper end of the insulated conduit is at least a two-phase fluid.

It will be appreciated that the body of water can be the sea, a natural/man-made lake, or a water-filled subterranean cavity.

Two or more installations according to the embodiment described in connection with FIG. 1 can be arranged such that the hood of each installation is located over an individual vent. The upper ends of the insulated conduits of the installations can be arranged below the sea surface to form a horizontal array of plumes.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An installation for conveying superheated fluid discharged from a vent located at or near the base of a body of water, the installation comprising:
a hood for locating the installation over the vent; and
an insulated conduit that is in fluid communication with the hood and extends upwardly through the body of water.

2. An installation according to claim 1, wherein the conduit comprises a series of cylindrical sections, the internal diameter of the cylindrical sections increasing with distance from the hood.

3. An installation according to claim 2, wherein the series of cylindrical sections is configured to maintain an approximately constant fluid velocity within the conduit.

4. An installation according to claim 2, wherein the series of cylindrical sections is constructed such that the pressure tolerance of sections within the series increases with distance from the hood.

5. An installation according to claim 2, wherein the conduit further comprises one or more conical sections that interconnect adjacent cylindrical sections within the series.

6. An installation according to claim 5, wherein the series of cylindrical sections and the one or more conical sections are configured to maintain an approximately constant fluid velocity within the conduit.

7. An installation according to claim 5, wherein the series of cylindrical sections and the one or more conical sections are constructed such that the pressure tolerance of sections within the series increases with distance from the vent.

8. An installation according to claim 2, wherein the upper end of the cylindrical section that is connected to the hood is positioned at approximately the same depth as the depth of vapourization of fluid conveyed through the conduit.

9. An installation according to claim 1, wherein the hood is thermally insulated.

10. An installation according to claim 1, wherein the hood includes an overflow discharge.

11. An installation according to claim 10, wherein the overflow discharge is in the form of one or more holes located around the base of the hood.

12. An installation according to claim 1, further comprising a series of buoys and/or anchors attached to the insulated conduit to maintain the conduit in a generally constant configuration.

13. An installation according to claim 1, further comprising a heat engine that converts energy within the fluid exhausted from the conduit into mechanical motion.

14. An installation according to claim 13, wherein the heat engine is located at or above the surface of the body of water.

15. An installation according to claim 1, wherein the body of water is the sea, and the vent is located on or near the sea floor.

16. An installation according to claim 15, wherein the upper end of the insulated conduit terminates below the sea surface, such that fluid can be exhausted from the insulated conduit into the upper layers of the sea.

17. An installation according to claim 16, wherein the fluid exhausted from the insulated conduit creates a plume which causes the transport of surrounding sea water from one level in the sea to a higher level.

18. An installation according to claim 15, further comprising a bubble pump located beneath the sea surface, and the upper end of the insulated conduit terminates inside the bubble pump, such that fluid exhausted from the conduit drives the bubble pump.

19. An installation according to claim 18, wherein the bubble pump comprises a thin walled conduit.

20. An installation according to claim 1, wherein the vent is a natural hydrothermal vent.

21. An installation according to claim 1, further comprising a nuclear reactor that heats fluid that is discharged from the vent.

22. A combined installation for conveying superheated fluid discharged from a plurality of vents located on the sea floor, the combined installation comprising a plurality of individual installations each comprising a hood for locating the individual installation over a vent, and an insulated conduit that is in fluid communication with the hood and extends upwardly through the body of water, the hood of each individual installation being located over a respective one of the vents, and the upper ends of the insulated conduits of the individual installations being arranged below the sea surface to form a vertical set of plumes.

23. A method of conveying thermal energy from a vent located at or near the base of a body of water, the vent discharging superheated fluid, the method comprising the steps of:
a) installing an installation over the vent, the installation comprising a hood that is in fluid communication with an insulated conduit, such that superheated fluid discharged from the vent is directed by the hood into the insulated conduit; and
b) conveying fluid upwardly in the insulated conduit and through the body of water.

24. A method according to claim 23, wherein step (b) further comprises conveying the fluid in a manner such that the fluid at least partly vapourizes as it rises within the conduit.

25. A method according to claim 23, wherein the fluid at the upper end of the insulated conduit is at least a two-phase fluid.

26. A method according to claim 25, wherein the installation further comprises a heat engine that receives fluid exhausted from the conduit, and the method further comprises converting the enthalpy of the fluid into mechanical energy in the heat engine.

27. A method according to claim 25, wherein the body of water is the sea, and the method further comprises discharging fluid from the conduit below the sea surface such that the buoyancy of the at least two-phase fluid creates a plume that mixes sea water between different levels by entrainment within the plume.

28. A method according to claim 25, wherein the body of water is the sea and the installation further comprises a bubble pump located beneath the sea surface and the upper end of the insulated conduit terminates inside the bubble pump, and the method further comprises discharging the at least two-phase fluid from the conduit inside the bubble pump to drive a bubble pump and create an upward flow of water through the bubble pump.

29. A method according to claim 27, whereby deep water containing nutrients are brought into the well-lit upper layers of the sea so as to increase the productivity of photosynthesizing organisms.

30. A method according to claim 29, whereby a marine ecosystem is created or enhanced in order to increase fish catch.

31. A method according to claim 29, whereby a marine ecosystem is created or enhanced in order to export carbon dioxide from the atmosphere by increased photosynthesis.

32. A method according to claim 27, comprising mixing layers of the sea in order to bring deep water of high alkalinity toward the sea surface and increase the solubility of carbon dioxide in the mixed layer.

33. A method according to claim 32, further comprising dissolving carbon dioxide from the atmosphere in the sea.

34. A method according to claim 23, wherein the installation further comprises a nuclear reactor, and the method further comprises heating fluid using energy generated by the reactor, the heated fluid being discharged from the vent.
